(19) United States
(12) Patent Application Publication
(10) Pub. No.: US 2025/0117683 A1
(43) Pub. Date: Apr. 10, 2025

(54) CONTEXTUALLY CALIBRATING QUANTUM HARDWARE BY MINIMIZING CONTEXTUAL COST FUNCTION

(71) Applicant: International Business Machines Corporation, Armonk, NY (US)

(72) Inventors: Seyed Alireza Seif Tabrizi, Adelphi, MD (US); Derek Wang, New York, NY (US); Iskandar Sitdikov, New York, NY (US)

(21) Appl. No.: 18/377,317

(22) Filed: Oct. 6, 2023

(51) Int. Cl. G06N 10/70; G06N 10/40

(52) U.S. Cl. CPC G06N 10/60

(57) ABSTRACT

A method, system, and computer program product for contextually calibrating quantum hardware. One or more contextual calibrations are selected or identified to minimize a contextual cost function of a quantum circuit. Examples of such contextual calibrations include, but are not limited to, tuning the amplitude, tuning the frequency duration, tuning the envelopes, recalibrating the error correction for specific qubits, recalibrating the measurement discriminator (identifies the specific quantum state), etc. The quantum hardware used to perform an execution of the quantum circuit may then be calibrated using the selected or identified contextual calibration(s). By minimizing the contextual cost function, such as via specific calibrations (e.g., tuning frequency duration, tuning amplitude), the performance of a general quantum device for a particular quantum circuit can be improved. For example, such contextual calibrations, such as at runtime, reduce the quantum device noise under different operating conditions thereby improving device performance.

### TECHNICAL FIELD

The present disclosure relates generally to quantum hardware calibrations, and more particularly to contextually calibrating quantum hardware by minimizing the contextual cost function.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

Techniques, such as quantum error mitigation techniques, have been developed to reduce (mitigate) the errors that occur in quantum computing algorithms. Such techniques involve running additional mitigation circuits or modified target circuits (target circuit is the quantum circuit executed on the quantum computer creating the quantum results). As a result, the use of quantum error mitigation techniques generally results in longer execution times or requires access to additional qubits for increased accuracy. That is, such quantum error mitigation methods trade additional execution time for increased accuracy.

By lowering the quantum device noise (noise subjected to by the quantum hardware), the overhead for quantum error mitigation may be reduced. Furthermore, quantum error correction is only feasible when the quantum device noise is below a threshold value. Furthermore, the utilization of the quantum processor can be improved when the quantum device noise is stable over time thereby requiring less frequent calibration.

Attempts have been made to lower and/or stabilize the quantum device noise by calibrating the quantum device based on maximizing the fidelity of each two-qubit gate when performed in isolation. However, such calibrations of the quantum device resulted in drastically different performances under different operating conditions.

As a result, there is not currently a means for effectively calibrating the quantum device (quantum hardware) so as to effectively lower the quantum device noise under different operating conditions.

### SUMMARY

In one embodiment of the present disclosure, a method for contextually calibrating quantum hardware comprises selecting or identifying one or more contextual calibrations to minimize a contextual cost function of a quantum circuit. The method further comprises calibrating the quantum hardware to perform an execution of the quantum circuit using the selected or the identified one or more contextual calibrations.

Additionally, in one embodiment of the present disclosure, the method further comprises determining whether the quantum hardware has been previously contextually calibrated defined by the contextual cost function.

Furthermore, in one embodiment of the present disclosure, the method additionally comprises representing the quantum circuit as a first directed acyclic graph.

Additionally, in one embodiment of the present disclosure, the method further comprises comparing the first directed acyclic graph with a plurality of directed acyclic graphs. Furthermore, the method comprises identifying the one or more contextual calibrations associated with a second directed acyclic graph of the plurality of directed acyclic graphs in response to the first directed acyclic graph matching the second directed acyclic graph.

Furthermore, in one embodiment of the present disclosure, the method additionally comprises determining the one or more contextual calibrations to minimize the contextual cost function of the quantum circuit in response to the quantum hardware not previously been contextually calibrated.

Additionally, in one embodiment of the present disclosure, the method further comprises measuring a fidelity for a layer of quantum gates of the quantum circuit. The method additionally comprises measuring individual quantum gate fidelities for quantum gates located in the layer of quantum gates of the quantum circuit.

Furthermore, in one embodiment of the present disclosure, the method additionally comprises selecting the one or more contextual calibrations to calibrate the layer of quantum gates of the quantum circuit in response to a difference between the measured individual quantum gate fidelities for quantum gates located in the layer of quantum gates of the quantum circuit and the measured fidelity for the layer of quantum gates of the quantum circuit exceeding a threshold value.

Additionally, in one embodiment of the present disclosure, the fidelity for the layer of quantum gates of the quantum circuit is measured by randomly sampling eigenstates of Pauli operators and measuring the sampled eigenstates of Pauli operators, where an increase in the fidelity for the layer of quantum gates of the quantum circuit is associated with a decrease in the contextual cost function.

Furthermore, in one embodiment of the present disclosure, the selected or the identified one or more contextual calibrations comprise one or more of the following in the group consisting of: tuning amplitude, tuning frequency duration, tuning envelopes, recalibrating error correction for specific qubits, and recalibrating a measurement discriminator.

Other forms of the embodiments of the method described above are in a system and in a computer program product.

Accordingly, embodiments of the present disclosure improve the performance of a general quantum device for a particular quantum circuit by minimizing the contextual cost function, such as via specific calibrations (e.g., tuning frequency duration, tuning amplitude).

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for contextually calibrating quantum hardware by minimizing the contextual cost function in accordance with an embodiment of the present disclosure;

FIG. 3 illustrates optimizing the measurement discriminator for a single qubit discriminator in accordance with an embodiment of the present disclosure;

FIG. 4 illustrates optimizing the measurement discriminator for a multi-qubit discriminator with crosstalk in accordance with an embodiment of the present disclosure;

FIG. 5 illustrates an embodiment of the present disclosure of the hardware configuration of the classical computer which is representative of a hardware environment for practicing the present disclosure;

FIG. 6 is a flowchart of a method for contextually calibrating quantum hardware by minimizing the contextual cost function in accordance with an embodiment of the present disclosure;

FIG. 7 is a flowchart of a method for determining if the quantum hardware has been previously contextually calibrated in accordance with an embodiment of the present disclosure; and

FIG. 8 is a flowchart of a method for selecting the contextual calibrations to minimize the contextual cost function of a quantum circuit in accordance with an embodiment of the present disclosure.

### DETAILED DESCRIPTION

In one embodiment of the present disclosure, a method for contextually calibrating quantum hardware comprises selecting or identifying one or more contextual calibrations to minimize a contextual cost function of a quantum circuit. The method further comprises calibrating the quantum hardware to perform an execution of the quantum circuit using the selected or the identified one or more contextual calibrations.

In this manner, the performance of a general quantum device for a particular quantum circuit is improved by minimizing the contextual cost function, such as via specific calibrations (e.g., tuning frequency duration, tuning amplitude).

Additionally, in one embodiment of the present disclosure, the method further comprises determining whether the quantum hardware has been previously contextually calibrated defined by the contextual cost function.

In this manner, previously performed contextual calibrations may be utilized thereby reducing the need to repeat calibrations.

Furthermore, in one embodiment of the present disclosure, the method additionally comprises representing the quantum circuit as a first directed acyclic graph.

In this manner, it may be determined whether the quantum hardware has been previously contextually calibrated defined by the contextual cost function.

Additionally, in one embodiment of the present disclosure, the method further comprises comparing the first directed acyclic graph with a plurality of directed acyclic graphs. Furthermore, the method comprises identifying the one or more contextual calibrations associated with a second directed acyclic graph of the plurality of directed acyclic graphs in response to the first directed acyclic graph matching the second directed acyclic graph.

In this manner, one or more contextual calibrations are identified to minimize a contextual cost function of a quantum circuit.

Furthermore, in one embodiment of the present disclosure, the method additionally comprises determining the one or more contextual calibrations to minimize the contextual cost function of the quantum circuit in response to the quantum hardware not previously been contextually calibrated.

In this manner, the quantum hardware may be contextually calibrated by minimizing the contextual cost function of the quantum circuit.

Additionally, in one embodiment of the present disclosure, the method further comprises measuring a fidelity for a layer of quantum gates of the quantum circuit. The method additionally comprises measuring individual quantum gate fidelities for quantum gates located in the layer of quantum gates of the quantum circuit.

In this manner, it may be determined whether a calibration is to be performed on the quantum hardware based on such measurements.

Furthermore, in one embodiment of the present disclosure, the method additionally comprises selecting the one or more contextual calibrations to calibrate the layer of quantum gates of the quantum circuit in response to a difference between the measured individual quantum gate fidelities for quantum gates located in the layer of quantum gates of the quantum circuit and the measured fidelity for the layer of quantum gates of the quantum circuit exceeding a threshold value.

In this manner, the layer of quantum gates of a quantum circuit is calibrated with selected contextual calibrations when the difference between the measured individual quantum gate fidelities for quantum gates located in the layer of quantum gates of the quantum circuit and the measured fidelity for the layer of quantum gates of the quantum circuit exceeds a threshold value.

Additionally, in one embodiment of the present disclosure, the fidelity for the layer of quantum gates of the quantum circuit is measured by randomly sampling eigenstates of Pauli operators and measuring the sampled eigenstates of Pauli operators, where an increase in the fidelity for the layer of quantum gates of the quantum circuit is associated with a decrease in the contextual cost function.

In this manner, the contextual cost function is minimized by increasing the fidelity for the layer of quantum gates of the quantum circuit.

Furthermore, in one embodiment of the present disclosure, the selected or the identified one or more contextual calibrations comprise one or more of the following in the group consisting of: tuning amplitude, tuning frequency duration, tuning envelopes, recalibrating error correction for specific qubits, and recalibrating a measurement discriminator.

In this manner, various types of contextual calibrations may be utilized to calibrate the quantum hardware to perform an execution of the quantum circuit.

Other forms of the embodiments of the method described above are in a system and in a computer program product.

As stated above, quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

Techniques, such as quantum error mitigation techniques, have been developed to reduce (mitigate) the errors that occur in quantum computing algorithms. Such techniques involve running additional mitigation circuits or modified target circuits (target circuit is the quantum circuit executed on the quantum computer creating the quantum results). As a result, the use of quantum error mitigation techniques generally results in longer execution times or requires access to additional qubits for increased accuracy. That is, such quantum error mitigation methods trade additional execution time for increased accuracy.

By lowering the quantum device noise (noise subjected to by the quantum hardware), the overhead for quantum error mitigation may be reduced. Furthermore, quantum error correction is only feasible when the quantum device noise is below a threshold value. Furthermore, the utilization of the quantum processor can be improved when the quantum device noise is stable over time thereby requiring less frequent calibration.

Attempts have been made to lower and/or stabilize the quantum device noise by calibrating the quantum device based on maximizing the fidelity of each two-qubit gate when performed in isolation. However, such calibrations of the quantum device resulted in drastically different performances under different operating conditions.

As a result, there is not currently a means for effectively calibrating the quantum device (quantum hardware) so as to effectively lower the quantum device noise under different operating conditions.

The embodiments of the present disclosure provide the means for effectively calibrating the quantum device (quantum hardware) so as to effectively lower the quantum device noise under different operating conditions by contextually calibrating the quantum hardware by minimizing the contextual cost function. “Contextual calibrations,” as used herein, refer to calibrating the quantum hardware based on the facts or circumstances that form the setting for calibrating the quantum hardware, such as the type of quantum gates being utilized by the quantum circuit (e.g., parallel gates, non-standard gates), the type of quantum circuit, observables (measurable properties of the quantum circuit), quantum error mitigation strategy, the desired trade-off between accuracy and time, etc. A “contextual cost function,” as used herein, refers to the measured difference between the predicted output of a quantum circuit and the true output, which is expressed as the negative of the fidelity, such as the fidelity of the layer of a quantum circuit. “Fidelity,” as used herein, refers to the measure of how close the final quantum state of the qubits (quantum mechanical analogue of classical bits) is to the ideal case. In one embodiment, one or more contextual calibrations, such as tuning the amplitude, tuning the frequency duration, tuning the envelopes, recalibrating the error correction for specific qubits, recalibrating the measurement discriminator (identifies the specific quantum state), etc., are selected in a manner that minimizes the contextual cost function of the quantum circuit. The quantum hardware may then be calibrated to perform an execution of the quantum circuit using such contextual calibrations. By minimizing the contextual cost function, quantum hardware may be able to be calibrated contextually thereby maximizing the fidelity of the two-qubit gates when performed simultaneously, which allows calibration to be performed only if it improves the fidelity of the quantum circuit thereby improving the performance of a general quantum device even under different operating conditions. These and other features will be discussed in further detail below.

In some embodiments of the present disclosure, the present disclosure comprises a method, system, and computer program product for contextually calibrating quantum hardware. In one embodiment of the present disclosure, one or more contextual calibrations are selected or identified to minimize a contextual cost function of a quantum circuit. Examples of such contextual calibrations include, but are not limited to, tuning the amplitude, tuning the frequency duration, tuning the envelopes, recalibrating the error correction for specific qubits, recalibrating the measurement discriminator (identifies the specific quantum state), etc. In one embodiment, the contextual calibration(s) are selected to minimize the contextual cost function of the quantum circuit using a trained machine learning model, where the machine learning model is trained to identify the contextual calibration(s) to be enacted to minimize the contextual cost function of the quantum circuit. Furthermore, in one embodiment, contextual calibrations are selected using reinforcement learning. In one embodiment, an agent learns by reinforcement, where the reward is predicting the correct contextual calibration which lowers the contextual cost function of the quantum circuit. The quantum hardware used to perform an execution of the quantum circuit may then be calibrated using the selected or identified contextual calibration(s). By minimizing the contextual cost function, such as via specific calibrations (e.g., tuning frequency duration, tuning amplitude), the performance of a general quantum device for a particular quantum circuit can be improved. For example, such contextual calibrations, such as at runtime, reduce the quantum device noise under different operating conditions thereby improving device performance.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

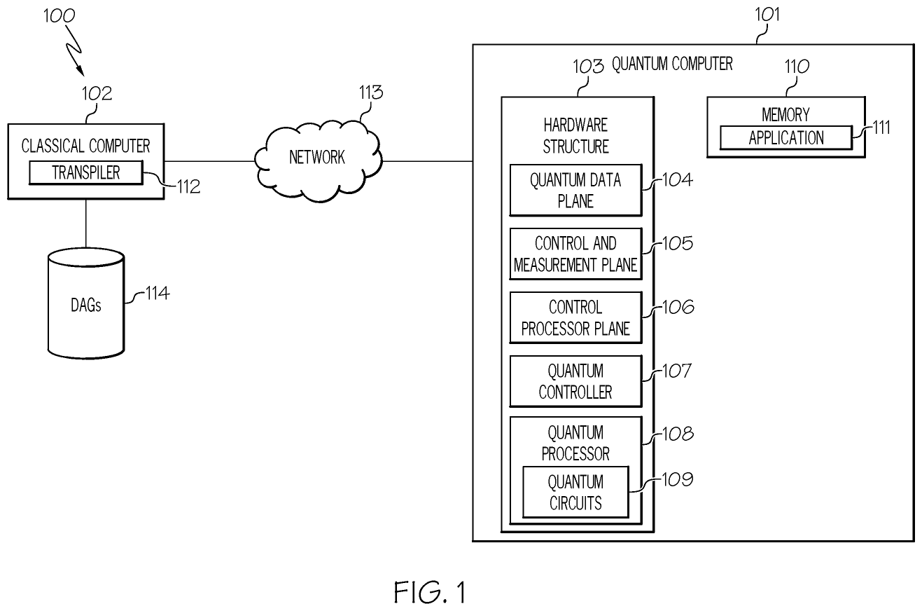

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to contextually calibrate quantum hardware by minimizing the contextual cost function as discussed further below.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

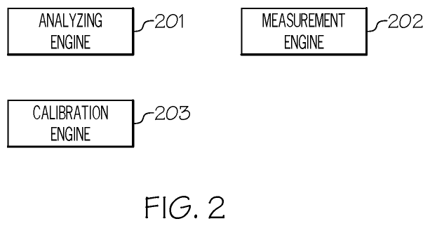

In one embodiment, memory 110 stores an application 111 that may be configured to implement one or more of the methods described herein in accordance with one or more embodiments. For example, application 111 may implement a program for contextually calibrating quantum hardware by minimizing the contextual cost function as discussed further below in connection with FIGS. 2-4 and 6-8. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

Furthermore, as shown in FIG. 1, classical computer 102 is connected to a database 114 storing directed acyclic graphs (DAGs) of previously evaluated quantum circuits. A directed acyclic graph (DAG), as used herein, refers to a directed graph that does not contain any cycles. In one embodiment, the DAG of the quantum circuit includes vertices that represent quantum logic gates (also referred to as simply “quantum gates” or “gates”) and the directed edges represent qubit dependencies. In one embodiment, such a DAG of the quantum circuit uses three types of nodes in the graph, namely, inputs, outputs, and operations. In one embodiment, the nodes are connected by directed edges that correspond to qubits. In one embodiment, the DAGs of quantum circuits are created using rustworkx (Python® package) in Qiskit®. In one embodiment, the DAGs of quantum circuits are created using the DAGCircuit function in Qiskit®.

In one embodiment, each DAG stored in database 114 is associated with a contextual calibration (e.g., tuning the amplitude, tuning the frequency duration, tuning the envelopes, recalibrating the error correction for specific qubits, recalibrating the measurement discriminator (identifies the specific quantum state), etc.) that was previously formulated for the quantum circuit corresponding to the DAG. In one embodiment, such contextual calibrations are also stored in database 114. “Contextual calibrations,” as used herein, refer to calibrating the quantum hardware based on the facts or circumstances that form the setting for calibrating the quantum hardware, such as the type of quantum gates being utilized by the quantum circuit (e.g., parallel gates, non-standard gates), the type of quantum circuit, observables, quantum error mitigation strategy, the desired trade-off between accuracy and time, etc. A “contextual cost function,” as used herein, refers to the measured difference between the predicted output of a quantum circuit and the true output, which is expressed as the negative of the fidelity, such as the fidelity of the layer of the quantum circuit. “Fidelity,” as used herein, refers to the measure of how close the final quantum state of the qubits (quantum mechanical analogue of classical bits) is to the ideal case.

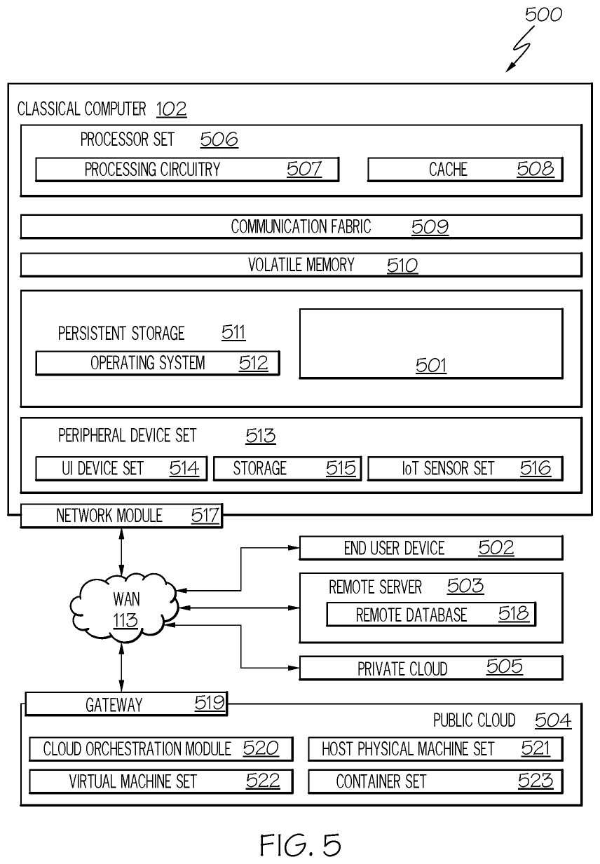

Furthermore, classical computer 102 is configured to contextually calibrate quantum hardware by minimizing the contextual cost function as discussed further below in connection with FIGS. 2-4 and 6-8. A description of the software components of classical computer 102 is provided below in connection with FIG. 2 and a description of the hardware configuration of classical computer 102 is provided further below in connection with FIG. 5.

System 100 is not to be limited in scope to any one particular network architecture. System 100 may include any number of quantum computers 101, classical computers 102, and networks 113.

A discussion regarding the software components used by classical computer 102 for contextually calibrating quantum hardware by minimizing the contextual cost function is provided below in connection with FIG. 2.

FIG. 2 is a diagram of the software components of classical computer 102 (FIG. 1) for contextually calibrating quantum hardware by minimizing the contextual cost function in accordance with an embodiment of the present disclosure.

Referring to FIG. 2, in conjunction with FIG. 1, classical computer 102 includes an analyzing engine 201 configured to determine if the quantum hardware has been previously contextually calibrated defined by the contextual cost function of the quantum circuit.

If the quantum hardware has been previously contextually calibrated defined by the contextual cost function of the quantum circuit, then analyzing engine 201 obtains such contextual calibration(s). Otherwise, the contextual calibration(s) to be performed on the quantum hardware that minimize the contextual cost function of the quantum circuit are determined.

In one embodiment, analyzing engine 201 determines if the quantum hardware has been previously contextually calibrated defined by the contextual cost function of the quantum circuit by receiving a quantum circuit to be represented as a directed acyclic graph (DAG). In one embodiment, such a quantum circuit may have been submitted to a quantum processing unit by a user, such as in a runtime environment. As discussed above, a directed acyclic graph (DAG), as used herein, refers to a directed graph that does not contain any cycles. In one embodiment, the DAG of the quantum circuit includes vertices that represent quantum logic gates (also referred to herein as “quantum gates” or “gates”) and the directed edges represent qubit dependencies. In one embodiment, such a DAG of the quantum circuit uses three types of nodes in the graph, namely, inputs, outputs, and operations. In one embodiment, the nodes are connected by directed edges that correspond to qubits.

In one embodiment, analyzing engine 201 represents a quantum circuit (e.g., quantum circuit) as a DAG using rustworkx (Python® package) in Qiskit®. In another embodiment, analyzing engine 201 represents a quantum circuit (e.g., quantum circuit) as a DAG using the DAGCircuit function in Qiskit®.

In one embodiment, analyzing engine 201 determines if the directed acyclic graph (DAG) of the received quantum circuit (e.g., quantum circuit 109) corresponds to a DAG stored in database 114 of a previously evaluated quantum circuit. As discussed above, in one embodiment, each DAG stored in database 114 is associated with a contextual calibration (e.g., tuning the amplitude, tuning the frequency duration, tuning the envelopes, recalibrating the error correction for specific qubits, recalibrating the measurement discriminator (identifies the specific quantum state), etc.) that was previously formulated for the quantum circuit corresponding to the DAG. In one embodiment, such contextual calibrations are also stored in database 114. “Contextual calibrations,” as used herein, refer to calibrating the quantum hardware based on the facts or circumstances that form the setting for calibrating the quantum hardware, such as the type of quantum gates being utilized by the quantum circuit (e.g., parallel gates, non-standard gates), the type of quantum circuit, observables, quantum error mitigation strategy, the desired trade-off between accuracy and time, etc. A “contextual cost function,” as used herein, refers to the measured difference between the predicted output of a quantum circuit and the true output, which is expressed as the negative of the fidelity, such as the fidelity of the layer of the quantum circuit. “Fidelity,” as used herein, refers to the measure of how close the final quantum state of the qubits (quantum mechanical analogue of classical bits) is to the ideal case.

In one embodiment, analyzing engine 201 determines if the DAG of the received quantum circuit matches any of the DAGs stored in database 114. “Matching,” as used herein, refers to matching a user-designated threshold number or percentage of vertices of the DAGs in question and/or matching a user-designated threshold number or percentage of edges of the DAGs in question. In one embodiment, analyzing engine 201 utilizes various software tools for determining if the DAG of the received quantum circuit matches any of the DAGs stored in database 114, such as, but are not limited to, iGraphMatch, GraphZero, MatchGraph, Python® library NetworkX, etc.

If there is a match between the DAG of the received quantum circuit with a DAG stored in database 114, then analyzing engine 201 identifies the contextual calibration(s) associated with the matching directed acyclic graph from database 114. Examples of such contextual calibration(s) include, but are not limited to, tuning the amplitude, tuning the frequency duration, tuning the envelopes, recalibrating the error correction for specific qubits, recalibrating the measurement discriminator (identifies the specific quantum state), etc.

Furthermore, as discussed above, if the quantum hardware has not previously been contextually calibrated defined by the contextual cost function of the quantum circuit, then the contextual calibration(s) to be performed on the quantum hardware that minimize the contextual cost function of the quantum circuit are determined.

In one embodiment, such contextual calibration(s) to be performed on the quantum hardware that minimize the contextual cost function of the quantum circuit are determined by measurement engine 202 of classical computer 102.

In one embodiment, such a determination is performed by measurement engine 202 by measuring a fidelity for a layer of quantum gates of the received quantum circuit (e.g., quantum circuit 109), which is denoted herein as F_{layer}^{exp}. As discussed above, “fidelity,” as used herein, refers to the measure of how close the final quantum state of the qubits (quantum mechanical analogue of classical bits) is to the ideal case. In one embodiment, measurement engine 202 performs such a measurement if there is not a match between the DAG of the received quantum circuit with a DAG stored in database 114.

In one embodiment, measurement engine 202 measures the fidelity of the layer of quantum gates of the received quantum circuit using direct fidelity estimation, which uses knowledge about the ideal target state or process to perform a tailored set of measurements. In such a method, only a constant number of Pauli expectation values are measured, selected at random according to an importance-weighting rule.

In one embodiment, measurement engine 202 measures the fidelity of the layer of quantum gates of the received quantum circuit using quantum state tomography. In quantum state tomography, the quantum state is reconstructed using measurements or an ensemble of identical quantum states. In one embodiment, to uniquely identify the state, the measurements are tomographically complete. That is, the measured operators form an operator basis on the Hilbert space of the system providing all the information about the state.

In one embodiment, measurement engine 202 measures the fidelity of the layer of quantum gates of the received quantum circuit using a trained machine learning model. In one embodiment, measurement engine 202 trains the machine learning model in a supervised manner using smaller or simpler quantum circuits for which the fidelity can be estimated using techniques, such as direct fidelity estimation and quantum state tomography.

In one embodiment, measurement engine 202 builds and trains a machine learning model to predict the measurement of the fidelity of the layer of quantum gates of a quantum circuit (e.g., quantum circuit 109).

In one embodiment, the machine learning model is trained to predict the measurement of the fidelity of the layer of quantum gates of a quantum circuit based on a sample data set that includes the measured fidelities of the layers of quantum gates of the quantum circuits, such as measurements provided using techniques, such as direct fidelity estimation and quantum state tomography. In one embodiment, such a sample data set is compiled by an expert.

Furthermore, in one embodiment, the sample data set discussed above is referred to herein as the “training data,” which is used by a machine learning algorithm to make predictions as to the measurement of the fidelity of the layer of quantum gates of a quantum circuit. The algorithm iteratively makes predictions on the training data as to the measurement of the fidelity of the layer of quantum gates of a quantum circuit until the predictions achieve the desired accuracy as determined by an expert. Examples of such learning algorithms include nearest neighbor, Naïve Bayes, decision trees, linear regression, support vector machines, and neural networks.

In one embodiment, upon training the machine learning model to predict the measurement of the fidelity of the layer of quantum gates of a quantum circuit, measurement engine 202 obtains the measurement of the fidelity of the layer of quantum gates of a quantum circuit based on inputting the layer of quantum gates to the trained machine learning model.

Additionally, in one embodiment, measurement engine 202 measures the individual gate fidelities for the quantum gates located in the layer of quantum gates of the received quantum circuit (e.g., quantum circuit 109). In one embodiment, measurement engine 202 measures the product of the individual gate fidelities, denoted by F_{layer}^{est}.

In one embodiment, measurement engine 202 measures the individual gate fidelities for the quantum gates located in the layer of quantum gates of the received quantum circuit using standard randomized benchmarking.

In one embodiment, measurement engine 202 measures the individual gate fidelities for the quantum gates located in the layer of quantum gates of the received quantum circuit by computing the output differences between the ideal quantum gate and the quantum gate in question.

In one embodiment, measurement engine 202 measures the individual gate fidelities for the quantum gates located in the layer of quantum gates of the received quantum circuit by performing quantum gate set tomography in Qiskit®.

In one embodiment, if F_{layer}^{est}−F_{layer}^{exp} is greater than a threshold value (“calibration threshold”), which may be user-designated, then calibration is performed by calibration engine 203 of classical computer 102, such as calibrating the quantum gates as a layer. Otherwise, calibration is not performed on the layer of the received quantum circuit.

In one embodiment, as discussed in further detail below, calibration engine 203 calibrates the quantum hardware with the selected contextual calibration(s) (e.g., tuning the amplitude, tuning the frequency duration, tuning envelopes, recalibrating the error correction for specific qubits, recalibrating the measurement discriminator, etc.) used to minimize the contextual cost function of the received quantum circuit or with the identified contextual calibration(s) associated with the matching directed acyclic graph (discussed above).

In one embodiment, calibration engine 203 calibrates the quantum hardware by measuring the fidelity (F_{layer}^{exp}) of a layer of quantum gates of the received quantum circuit (e.g., quantum circuit 109) as well as obtaining the state preparation and measurement (SPAM) errors (F_{SPAM}) by randomly sampling the eigenstates of Pauli operators and measuring the sampled eigenstates of the Pauli operators. That is, calibration engine 203 selects a Pauli operation P, prepares its eigenstate by appropriately applying S (intrinsic quantum operation sometimes called the “phase gate”) or H (Hilbert space), applying the layer of quantum gates of the received quantum circuit, and measuring P. In one embodiment, calibration engine 203 averages over P, resulting in the fidelity measurement of F, where F=F_{layer}^{exp}*F_{SPAM}.

In one embodiment, the contextual cost function is defined as corresponding to −F. As discussed above, the “contextual cost function,” as used herein, refers to the measured difference between the predicted output of a quantum circuit and the true output, which is expressed as the negative of the fidelity. Because F_{SPAM} is fixed and is not being calibrated, any decrease in the cost function is associated with an increase in F_{layer}^{exp}.

As a result, in one embodiment, the contextual cost function is minimized by increasing F_{layer}^{exp} by appropriately selecting contextual calibrations by calibration engine 203 to calibrate the quantum hardware to perform the execution of the received quantum circuit using the selected/identified contextual calibrations. By minimizing the contextual cost function, quantum hardware is able to be calibrated contextually thereby maximizing the fidelity of the quantum gates when performed simultaneously which improves the performance of the general quantum device even under different operating conditions.

In one embodiment, such contextual calibrations include, but are not limited to, calibrating pulse parameters, such as tuning the amplitude, tuning the frequency duration, tuning envelopes, etc., recalibrating the error correction for specific qubits, recalibrating the measurement discriminator, etc.

In one embodiment, calibration engine 203 measures F_{layer}^{exp}, either by randomly sampling eigenstates of Pauli operators and measuring them or in the same manner as measurement engine 202 measures F_{layer}^{exp} as discussed above, to determine if the calibrations increase F_{layer}^{exp} thereby decreasing the cost function after each contextual calibration is selected by calibration engine 203 (e.g., increase frequency duration by 1 ms). In one embodiment, such contextual calibrations are continuously selected and tested by calibration engine 203 until the contextual cost function can no longer be lowered.

In one embodiment, calibration engine 203 selects the contextual calibration(s) to minimize the contextual cost function of the received quantum circuit using a trained machine learning model. In one embodiment, calibration engine 203 trains the machine learning model in a supervised manner to identify the contextual calibration(s) to be enacted to minimize the contextual cost function of the received quantum circuit.

In one embodiment, calibration engine 203 builds and trains a machine learning model to predict the contextual calibration(s) to be enacted to minimize the contextual cost function of the received quantum circuit.

In one embodiment, the machine learning model is trained to predict the contextual calibration(s) to be enacted to minimize the contextual cost function of the received quantum circuit based on a sample data set that includes values for F_{layer}^{exp}, values for the differences between the F_{layer}^{est}−F_{layer}^{exp}, and the directed acyclic graphs of the quantum circuits along with the corresponding contextual calibrations to be utilized to minimize the contextual cost function. In one embodiment, such a sample data set is compiled by an expert.

Furthermore, in one embodiment, the sample data set discussed above is referred to herein as the “training data,” which is used by a machine learning algorithm to make predictions as to the contextual calibration(s) to be enacted to minimize the contextual cost function of the received quantum circuit. The algorithm iteratively makes predictions on the training data as to the contextual calibration(s) to be enacted to minimize the contextual cost function of the received quantum circuit until the predictions achieve the desired accuracy as determined by an expert. Examples of such learning algorithms include nearest neighbor, Naïve Bayes, decision trees, linear regression, support vector machines, and neural networks.

In one embodiment, upon training the machine learning model to predict the contextual calibration(s) to be enacted to minimize the contextual cost function of the received quantum circuit, calibration engine 203 obtains the contextual calibration(s) to be enacted to minimize the contextual cost function of the received quantum circuit based on inputting F_{layer}^{exp}, the difference between F_{layer}^{est}−F_{layer}^{exp}, and the directed acyclic graph of the received quantum circuit to the trained machine learning model.

In one embodiment, contextual calibrations are selected by calibration engine 203 using reinforcement learning. In one embodiment, an agent learns by reinforcement, where the reward is predicting the correct contextual calibration which lowers the contextual cost function of the received quantum circuit.

In one embodiment, such selected contextual calibrations are stored, such as in database 114, to be used in future calibrations.

In one embodiment, calibration engine 203 calibrates the quantum hardware with such selected contextual calibration(s) (e.g., tuning the amplitude, tuning the frequency duration, tuning envelopes, recalibrating the error correction for specific qubits, recalibrating the measurement discriminator, etc.) used to minimize the contextual cost function of the received quantum circuit.

As discussed above, an example of a contextual calibration corresponds to recalibrating the measurement discriminator. In one embodiment, calibration engine 203 recalibrates the measurement discriminator by minimizing the contextual cost function in situations in which the estimator (estimates the quantum state) is provided a large weight Pauli operator with neighboring qubits. Neighboring qubits, as used herein, refer to those qubits within a user-designated distance (e.g., 1 nanometer) from each other. Pauli operators, such as I, X, Y, and Z, allow one to express the four possible effects of the environment on a qubit in the state |ψ [symbol] . That is, such Pauli operators form a complete basis for the set of all unitary transformations on a single qubit. As a result, any quantum circuit on a single qubit can be represented by a linear combination (weighted sum) of the I, X, Y, and Z operators applied to that qubit.

In one embodiment, in situations in which the Pauli observable is non-trivial (not easy to express the effects of the environment on the qubit) on the neighboring qubits, calibration engine 203 prepares the random product initial states psi_i in the computational basis, and calculates the expectation value of pauli_observable_modfied (i.e., the modified Pauli observable) that is similar to pauli_observable (i.e., the Pauli observable), except that all non-trivial Pauli operators are replaced with Z. In one embodiment, the pauli_observable_modfied corresponds to s_i=+1 or −1. An observable, as used herein, is a measurable property of the quantum circuit, such as whether a qubit measures to be |0 [symbol] or |1 [symbol] in the standard computational basis. In the Pauli basis, this corresponds to the Z observable.

Furthermore, in one embodiment, calibration engine 203 then optimizes the contextual cost function cost_multi_measure=sum_i(s_i tr(pauli_observable_modefied \psi_i). Optimizing the contextual cost function, as used herein, corresponds to minimizing the contextual cost function as previously discussed.

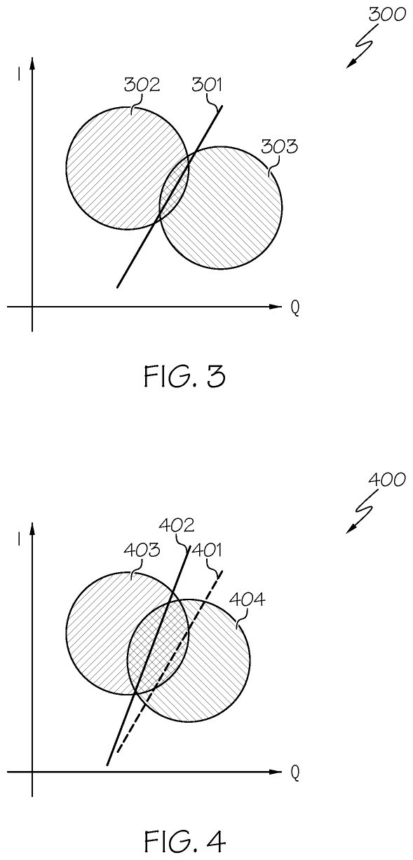

An illustration of optimizing the measurement discriminator for a single qubit discriminator is provided in FIG. 3.

FIG. 3 illustrates optimizing the measurement discriminator for a single qubit discriminator in accordance with an embodiment of the present disclosure.

Referring to FIG. 3, FIG. 3 is a graph 300 of current (I) versus charge (Q), where line 301 indicates an optimized measurement between the states +1 (represented by circle 302) and −1 (represented by circle 303).

An illustration of optimizing the measurement discriminator for a multi-qubit discriminator with crosstalk is provided in FIG. 4.

FIG. 4 illustrates optimizing the measurement discriminator for a multi-qubit discriminator with crosstalk in accordance with an embodiment of the present disclosure. Crosstalk, as used herein, refers to the effect of a desired action on one or more qubits unintentionally affecting one or more other qubits.

Referring to FIG. 4, FIG. 4 is a graph 400 of current (I) versus charge (Q), where line 401 represents the old discriminator and line 402 represents the multi-qubit optimized discriminator with an optimized measurement between the states +1 (represented by circle 403) and −1 (represented by circle 404).

By minimizing the contextual cost function, i.e., optimizing the contextual cost function, such as via specific calibrations (e.g., tuning frequency duration, tuning amplitude), the performance of a general quantum device for a particular quantum circuit can be improved. For example, such contextual calibrations, such as at runtime, reduce the quantum device noise under different operating conditions thereby improving device performance.

A further description of these and other functions is provided below in connection with the discussion of the method for contextually calibrating quantum hardware by minimizing the contextual cost function.

Prior to the discussion of the method for contextually calibrating quantum hardware by minimizing the contextual cost function, a description of the hardware configuration of classical computer 102 (FIG. 1) is provided below in connection with FIG. 5.

Referring now to FIG. 5, in conjunction with FIG. 1, FIG. 5 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code 501 involved in performing the inventive methods, such as contextually calibrating quantum hardware by minimizing the contextual cost function. In addition to block 501, computing environment 500 includes, for example, classical computer 102, network 113, such as a wide area network (WAN), end user device (EUD) 502, remote server 503, public cloud 504, and private cloud 505. In this embodiment, classical computer 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically classical computer 102, to keep the presentation as simple as possible. Classical computer 102 may be located in a cloud, even though it is not shown in a cloud in FIG. 5. On the other hand, classical computer 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto classical computer 102 to cause a series of operational steps to be performed by processor set 506 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 510 is located in a single package and is internal to classical computer 102, but, alternatively or additionally, the volatile memory may be distributed over multiple packages and/or located externally with respect to classical computer 102.

Persistent Storage 511 is any form of non-volatile storage for computers that is now known or to be developed in the future. The non-volatility of this storage means that the stored data is maintained regardless of whether power is being supplied to classical computer 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows classical computer 102 to communicate with other computers through WAN 113. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to classical computer 102 from an external computer or external storage device through a network adapter card or network interface included in network module 517.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates classical computer 102), and may take any of the forms discussed above in connection with classical computer 102. EUD 502 typically receives helpful and useful data from the operations of classical computer 102. For example, in a hypothetical case where classical computer 102 is designed to provide a recommendation to an end user, this recommendation would typically be communicated from network module 517 of classical computer 102 through WAN 113 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to classical computer 102. Remote server 503 may be controlled and used by the same entity that operates classical computer 102. Remote server 503 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to contextually calibrate quantum hardware by minimizing the contextual cost function. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for contextually calibrating quantum hardware by minimizing the contextual cost function, may be embodied in an application specific integrated circuit.

As stated above, quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. Techniques, such as quantum error mitigation techniques, have been developed to reduce (mitigate) the errors that occur in quantum computing algorithms. Such techniques involve running additional mitigation circuits or modified target circuits (target circuit is the quantum circuit executed on the quantum computer creating the quantum results). As a result, the use of quantum error mitigation techniques generally results in longer execution times or requires access to additional qubits for increased accuracy. That is, such quantum error mitigation methods trade additional execution time for increased accuracy. By lowering the quantum device noise (noise subjected to by the quantum hardware), the overhead for quantum error mitigation may be reduced. Furthermore, quantum error correction is only feasible when the quantum device noise is below a threshold value. Furthermore, the utilization of the quantum processor can be improved when the quantum device noise is stable over time thereby requiring less frequent calibration. Attempts have been made to lower and/or stabilize the quantum device noise by calibrating the quantum device based on maximizing the fidelity of each two-qubit gate when performed in isolation. However, such calibrations of the quantum device resulted in drastically different performances under different operating conditions. As a result, there is not currently a means for effectively calibrating the quantum device (quantum hardware) so as to effectively lower the quantum device noise under different operating conditions.

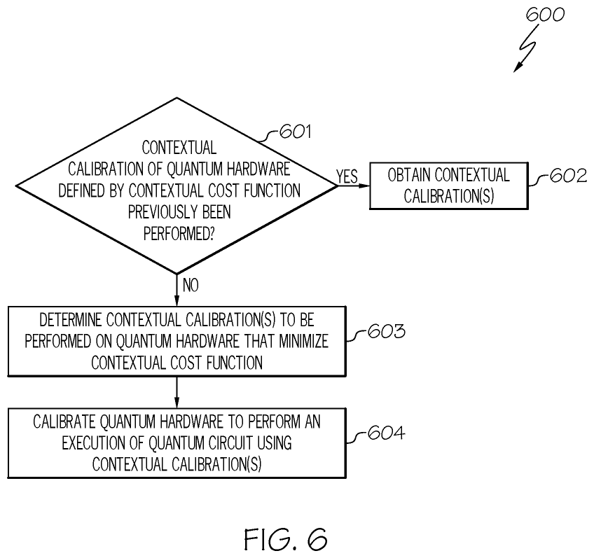

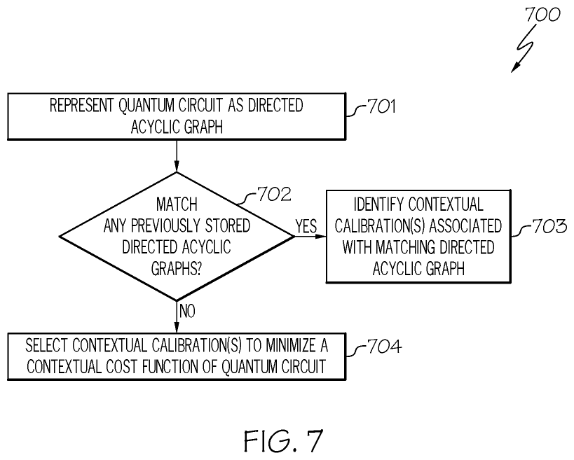

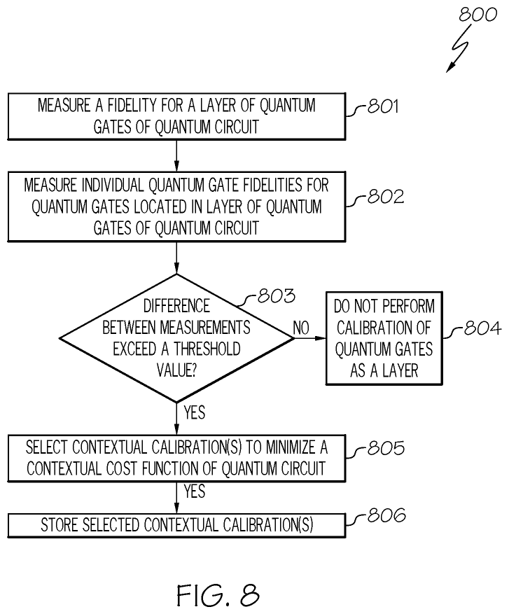

The embodiments of the present disclosure provide the means for effectively calibrating the quantum device (quantum hardware) so as to effectively lower the quantum device noise under different operating conditions by contextually calibrating the quantum hardware by minimizing the contextual cost function as discussed below in connection with FIGS. 6-8. FIG. 6 is a flowchart of a method for contextually calibrating quantum hardware by minimizing the contextual cost function. FIG. 7 is a flowchart of a method for determining if the quantum hardware has been previously contextually calibrated. FIG. 8 is a flowchart of a method for selecting the contextual calibrations to minimize the contextual cost function of a quantum circuit.

As stated above, FIG. 6 is a flowchart of a method 600 for contextually calibrating quantum hardware by minimizing the contextual cost function in accordance with an embodiment of the present disclosure.

Referring to FIG. 6, in conjunction with FIGS. 1-5, in step 601, analyzing engine 201 of classical computer 102 determines if the quantum hardware has been previously contextually calibrated defined by the contextual cost function of a quantum circuit, such as a received quantum circuit.

If the quantum hardware has been previously contextually calibrated defined by the contextual cost function of the quantum circuit, then, in step 602, analyzing engine 201 of classical computer 102 obtains such contextual calibration(s).

If, however, the quantum hardware has not previously been contextually calibrated defined by the contextual cost function of the quantum circuit, then, in step 603, measurement engine 202 of classical computer determines the contextual calibration(s) to be performed on the quantum hardware that minimize the contextual cost function of the quantum circuit.

A discussion regarding determining if the quantum hardware has been previously contextually calibrated is provided below in connection with FIG. 7.

FIG. 7 is a flowchart of a method 700 for determining if the quantum hardware has been previously contextually calibrated in accordance with an embodiment of the present disclosure.

Referring to FIG. 7, in conjunction with FIGS. 1-6, in step 701, analyzing engine 201 of classical computer 102 represents a received quantum circuit as a directed acyclic graph (DAG).

As discussed above, in one embodiment, analyzing engine 201 receives a quantum circuit to be represented as a directed acyclic graph (DAG). In one embodiment, such a quantum circuit may have been submitted to a quantum processing unit by a user, such as in a runtime environment. As discussed above, a directed acyclic graph (DAG), as used herein, refers to a directed graph that does not contain any cycles. In one embodiment, the DAG of the quantum circuit includes vertices that represent quantum gates and the directed edges represent qubit dependencies. In one embodiment, such a DAG of the quantum circuit uses three types of nodes in the graph, namely, inputs, outputs, and operations. In one embodiment, the nodes are connected by directed edges that correspond to qubits.

In one embodiment, analyzing engine 201 represents a quantum circuit (e.g., quantum circuit) as a DAG using rustworkx (Python® package) in Qiskit®. In another embodiment, analyzing engine 201 represents a quantum circuit (e.g., quantum circuit) as a DAG using the DAGCircuit function in Qiskit®.

In one embodiment, analyzing engine 201 determines if the directed acyclic graph (DAG) of the received quantum circuit (e.g., quantum circuit 109) corresponds to a DAG stored in database 114 of a previously evaluated quantum circuit. As discussed above, in one embodiment, each DAG stored in database 114 is associated with a contextual calibration (e.g., tuning the amplitude, tuning the frequency duration, tuning the envelopes, recalibrating the error correction for specific qubits, recalibrating the measurement discriminator (identifies the specific quantum state), etc.) that was previously formulated for the quantum circuit corresponding to the DAG. In one embodiment, such contextual calibrations are also stored in database 114. “Contextual calibrations,” as used herein, refer to calibrating the quantum hardware based on the facts or circumstances that form the setting for calibrating the quantum hardware, such as the type of quantum gates being utilized by the quantum circuit (e.g., parallel gates, non-standard gates), the type of quantum circuit, observables, quantum error mitigation strategy, the desired trade-off between accuracy and time, etc. A “contextual cost function,” as used herein, refers to the measured difference between the predicted output of a quantum circuit and the true output, which is expressed as the negative of the fidelity, such as the fidelity of the layer of the quantum circuit. “Fidelity,” as used herein, refers to the measure of how close the final quantum state of the qubits (quantum mechanical analogue of classical bits) is to the ideal case.

In step 702, analyzing engine 201 of classical computer 102 determines if the DAG of the received quantum circuit matches any of the DAGs stored in database 114. “Matching,” as used herein, refers to matching a user-designated threshold number or percentage of vertices of the DAGs in question and/or matching a user-designated threshold number or percentage of edges of the DAGs in question. In one embodiment, analyzing engine 201 utilizes various software tools for determining if the DAG of the received quantum circuit matches any of the DAGs stored in database 114, such as, but are not limited to, iGraphMatch, GraphZero, MatchGraph, Python® library NetworkX, etc.

If there is a match between the DAG of the received quantum circuit with a DAG stored in database 114, then, in step 703, analyzing engine 201 of classical computer 102 identifies the contextual calibration(s) associated with the matching directed acyclic graph from database 114. Examples of such contextual calibration(s) include tuning the amplitude, tuning the frequency duration, tuning the envelopes, recalibrating the error correction for specific qubits, recalibrating the measurement discriminator (identifies the specific quantum state), etc.

If, however, there is not a match between the DAG of the received quantum circuit with a DAG stored in database 114, then, in step 704, measurement engine 202 of classical computer 102 selects the contextual calibration(s) to minimize the contextual cost function of the received quantum circuit.

A discussion regarding selecting the contextual calibration(s) to minimize the contextual cost function of the received quantum circuit is provided below in connection with FIG. 8.

FIG. 8 is a flowchart of a method 800 for selecting the contextual calibrations to minimize the contextual cost function of a quantum circuit in accordance with an embodiment of the present disclosure.

Referring to FIG. 8, in conjunction with FIGS. 1-7, in step 801, measurement engine 202 of classical computer 102 measures a fidelity for a layer of quantum gates of the received quantum circuit (e.g., quantum circuit 109), which is denoted herein as F_{layer}^{exp}. As discussed above, “fidelity,” as used herein, refers to the measure of how close the final quantum state of the qubits (quantum mechanical analogue of classical bits) is to the ideal case. In one embodiment, measurement engine 202 performs such a measurement if there is not a match between the DAG of the received quantum circuit with a DAG stored in database 114.

As stated above, in one embodiment, measurement engine 202 measures the fidelity of the layer of quantum gates of the received quantum circuit using direct fidelity estimation, which uses knowledge about the ideal target state or process to perform a tailored set of measurements. In such a method, only a constant number of Pauli expectation values are measured, selected at random according to an importance-weighting rule.

In one embodiment, measurement engine 202 measures the fidelity of the layer of quantum gates of the received quantum circuit using quantum state tomography. In quantum state tomography, the quantum state is reconstructed using measurements or an ensemble of identical quantum states. In one embodiment, to uniquely identify the state, the measurements are tomographically complete. That is, the measured operators form an operator basis on the Hilbert space of the system providing all the information about the state.

In one embodiment, measurement engine 202 measures the fidelity of the layer of quantum gates of the received quantum circuit using a trained machine learning model. In one embodiment, measurement engine 202 trains the machine learning model in a supervised manner using smaller or simpler quantum circuits for which the fidelity can be estimated using techniques, such as direct fidelity estimation and quantum state tomography.

In one embodiment, measurement engine 202 builds and trains a machine learning model to predict the measurement of the fidelity of the layer of quantum gates of a quantum circuit (e.g., quantum circuit 109).

In one embodiment, the machine learning model is trained to predict the measurement of the fidelity of the layer of quantum gates of a quantum circuit based on a sample data set that includes the measured fidelities of the layers of quantum gates of the quantum circuits, such as measurements provided using techniques, such as direct fidelity estimation and quantum state tomography. In one embodiment, such a sample data set is compiled by an expert.

Furthermore, in one embodiment, the sample data set discussed above is referred to herein as the “training data,” which is used by a machine learning algorithm to make predictions as to the measurement of the fidelity of the layer of quantum gates of a quantum circuit. The algorithm iteratively makes predictions on the training data as to the measurement of the fidelity of the layer of quantum gates of a quantum circuit until the predictions achieve the desired accuracy as determined by an expert. Examples of such learning algorithms include nearest neighbor, Naïve Bayes, decision trees, linear regression, support vector machines, and neural networks.

In one embodiment, upon training the machine learning model to predict the measurement of the fidelity of the layer of quantum gates of a quantum circuit, measurement engine 202 obtains the measurement of the fidelity of the layer of quantum gates of a quantum circuit based on inputting the layer of quantum gates to the trained machine learning model.

In step 802, measurement engine 202 of classical computer 102 measures the individual quantum gate fidelities for the quantum gates located in the layer of quantum gates of the received quantum circuit (e.g., quantum circuit 109). In one embodiment, measurement engine 202 measures the product of the individual gate fidelities, denoted by F_{layer}^{est}.

As discussed above, in one embodiment, measurement engine 202 measures the individual quantum gate fidelities for the quantum gates located in the layer of quantum gates of the received quantum circuit using standard randomized benchmarking.

In one embodiment, measurement engine 202 measures the individual gate fidelities for the quantum agates located in the layer of quantum gates of the received quantum circuit by computing the output differences between the ideal quantum gate and the quantum gate in question.

In one embodiment, measurement engine 202 measures the individual gate fidelities for the quantum gates located in the layer of quantum gates of the received quantum circuit by performing quantum gate set tomography in Qiskit®.

In step 803, calibration engine 203 of classical computer 102 determines whether the difference between the measurements of steps 801, 802 (F_{layer}^{est}−F_{layer}^{exp}) exceeds a threshold value (“calibration threshold”), which may be user-designated.

If F_{layer}^{est}−F_{layer}^{exp} is not greater than the threshold value (“calibration threshold”), then, in step 804, calibration engine 203 of classical computer 102 does not preform the calibration of the quantum gates as a layer of the received quantum circuit.

If, however, F_{layer}^{est}−F_{layer}^{exp} is greater than the threshold value (“calibration threshold”), then, in step 805, calibration engine 203 of classical computer 102 performs calibration, such as calibrating the quantum gates as a layer, by selecting the contextual calibration(s) to minimize the contextual cost function of the received quantum circuit.

As stated above, in one embodiment, calibration engine 203 selects the contextual calibration(s) to minimize the contextual cost function of the received quantum circuit using a trained machine learning model. In one embodiment, calibration engine 203 trains the machine learning model in a supervised manner to identify the contextual calibration(s) to be enacted to minimize the contextual cost function of the received quantum circuit.

In one embodiment, calibration engine 203 builds and trains a machine learning model to predict the contextual calibration(s) to be enacted to minimize the contextual cost function of the received quantum circuit.

In one embodiment, the machine learning model is trained to predict the contextual calibration(s) to be enacted to minimize the contextual cost function of the received quantum circuit based on a sample data set that includes values for F_{layer}^{exp}, values for the differences between the F_{layer}^{est}−F_{layer}^{exp}, and the directed acyclic graphs of the quantum circuits along with the corresponding contextual calibrations to be utilized to minimize the contextual cost function. In one embodiment, such a sample data set is compiled by an expert.

Furthermore, in one embodiment, the sample data set discussed above is referred to herein as the “training data,” which is used by a machine learning algorithm to make predictions as to the contextual calibration(s) to be enacted to minimize the contextual cost function of the received quantum circuit. The algorithm iteratively makes predictions on the training data as to the contextual calibration(s) to be enacted to minimize the contextual cost function of the received quantum circuit until the predictions achieve the desired accuracy as determined by an expert. Examples of such learning algorithms include nearest neighbor, Naïve Bayes, decision trees, linear regression, support vector machines, and neural networks.

In one embodiment, upon training the machine learning model to predict the contextual calibration(s) to be enacted to minimize the contextual cost function of the received quantum circuit, calibration engine 203 obtains the contextual calibration(s) to be enacted to minimize the contextual cost function of the received quantum circuit based on inputting F_{layer}^{exp}, the difference between F_{layer}^{est}−F_{layer}^{exp}, and the directed acyclic graph of the received quantum circuit to the trained machine learning model.

In one embodiment, contextual calibrations are selected by calibration engine 203 using reinforcement learning. In one embodiment, an agent learns by reinforcement, where the reward is predicting the correct contextual calibration which lowers the contextual cost function of the received quantum circuit.

In step 806, calibration engine 203 of classical computer 102 stores the selected contextual calibration(s), such as in database 114, to be used in future calibrations.

Returning to FIG. 6, in conjunction with FIGS. 1-5 and 7-8, in step 604, calibration engine 203 of classical computer 102 calibrates the quantum hardware with the selected contextual calibration(s) (e.g., tuning the amplitude, tuning the frequency duration, tuning envelopes, recalibrating the error correction for specific qubits, recalibrating the measurement discriminator, etc.) used to minimize the contextual cost function of the received quantum circuit (discussed above in connection with steps 603 and 805) or with the identified contextual calibration(s), such as associated with the matching directed acyclic graph (discussed above in connection with steps 602 and 703).

As discussed above, in one embodiment, calibration engine 203 calibrates the quantum hardware by measuring the fidelity (F_{layer}^{exp}) of a layer of quantum gates of the received quantum circuit (e.g., quantum circuit 109) as well as obtaining the state preparation and measurement (SPAM) errors (F_{SPAM}) by randomly sampling the eigenstates of Pauli operators and measuring the sampled eigenstates of the Pauli operators. That is, calibration engine 203 selects a Pauli operation P, prepares its eigenstate by appropriately applying S (intrinsic quantum operation sometimes called the “phase gate”) or H (Hilbert space), applying the layer of quantum gates of the received quantum circuit, and measuring P. In one embodiment, calibration engine 203 averages over P, resulting in the fidelity measurement of F, where F=F_{layer}^{exp}*F_{SPAM}.

In one embodiment, the contextual cost function is defined as corresponding to −F. As discussed above, the “contextual cost function,” as used herein, refers to the measured difference between the predicted output of a quantum circuit and the true output, which is expressed as the negative of the fidelity. Because F_{SPAM} is fixed and is not being calibrated, any decrease in the cost function is associated with an increase in F_{layer}^{exp}.

As a result, in one embodiment, the contextual cost function is minimized by increasing F_{layer}^{exp} by appropriately selecting contextual calibrations by calibration engine 203 to calibrate the quantum hardware to perform the execution of the received quantum circuit using the selected/identified contextual calibrations. By minimizing the contextual cost function, quantum hardware is able to be calibrated contextually thereby maximizing the fidelity of the quantum gates when performed simultaneously which improves the performance of the general quantum device even under different operating conditions.

In one embodiment, such contextual calibrations include, but are not limited to, calibrating pulse parameters, such as tuning the amplitude, tuning the frequency duration, tuning envelopes, etc., recalibrating the error correction for specific qubits, recalibrating the measurement discriminator, etc.

In one embodiment, calibration engine 203 measures F_{layer}^{exp}, either by randomly sampling eigenstates of Pauli operators and measuring them or in the same manner as measurement engine 202 measures F_{layer}^{exp} as discussed above, to determine if the calibrations increase F_{layer}^{exp} thereby decreasing the cost function after each contextual calibration is selected by calibration engine 203 (e.g., increase frequency duration by 1 ms). In one embodiment, such contextual calibrations are continuously selected and tested by calibration engine 203 until the contextual cost function can no longer be lowered.

Furthermore, as discussed above, an example of a contextual calibration corresponds to recalibrating the measurement discriminator. In one embodiment, calibration engine 203 recalibrates the measurement discriminator by minimizing the contextual cost function in situations in which the estimator (estimates the quantum state) is provided a large weight Pauli operator with neighboring qubits. Neighboring qubits, as used herein, refer to those qubits within a user-designated distance (e.g., 1 nanometer) from each other. Pauli operators, such as I, X, Y, and Z, allow one to express the four possible effects of the environment on a qubit in the state |ψ [symbol] . That is, such Pauli operators form a complete basis for the set of all unitary transformations on a single qubit. As a result, any quantum circuit on a single qubit can be represented by a linear combination (weighted sum) of the I, X, Y, and Z operators applied to that qubit.

In one embodiment, in situations in which the Pauli observable is non-trivial (not easy to express the effects of the environment on the qubit) on the neighboring qubits, calibration engine 203 prepares the random product initial states psi_i in the computational basis, and calculates the expectation value of pauli_observable_modfied (i.e., the modified Pauli observable) that is similar to pauli_observable (i.e., the Pauli observable), except that all non-trivial Pauli operators are replaced with Z. In one embodiment, the pauli_observable_modfied corresponds to s_i=+1 or −1. An observable, as used herein, is a measurable property of the quantum circuit, such as whether a qubit measures to be |0 [symbol] or |1 [symbol] in the standard computational basis. In the Pauli basis, this corresponds to the Z observable.

Furthermore, in one embodiment, calibration engine 203 then optimizes the contextual cost function cost_multi_measure=sum_i(s_i tr(pauli_observable_modefied \psi_i). Optimizing the contextual cost function, as used herein, corresponds to minimizing the contextual cost function as previously discussed.

An illustration of optimizing the measurement discriminator for a single qubit discriminator is provided in FIG. 3.

Referring to FIG. 3, FIG. 3 is a graph 300 of current (I) versus charge (Q), where line 301 indicates an optimized measurement between the states +1 (represented by circle 302) and −1 (represented by circle 303).

An illustration of optimizing the measurement discriminator for a multi-qubit discriminator with crosstalk is provided in FIG. 4.

Referring to FIG. 4, FIG. 4 is a graph 400 of current (1) versus charge (Q), where line 401 represents the old discriminator and line 402 represents the multi-qubit optimized discriminator with an optimized measurement between the states +1 (represented by circle 403) and −1 (represented by circle 404).

By minimizing the contextual cost function, i.e., optimizing the contextual cost function, such as via specific calibrations (e.g., tuning frequency duration, tuning amplitude), the performance of a general quantum device for a particular quantum circuit can be improved. For example, such contextual calibrations, such as at runtime, reduce the quantum device noise under different operating conditions thereby improving device performance.

Furthermore, the principles of the present disclosure improve the technology or technical field involving quantum hardware calibrations.

As discussed above, quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. Techniques, such as quantum error mitigation techniques, have been developed to reduce (mitigate) the errors that occur in quantum computing algorithms. Such techniques involve running additional mitigation circuits or modified target circuits (target circuit is the quantum circuit executed on the quantum computer creating the quantum results). As a result, the use of quantum error mitigation techniques generally results in longer execution times or requires access to additional qubits for increased accuracy. That is, such quantum error mitigation methods trade additional execution time for increased accuracy. By lowering the quantum device noise (noise subjected to by the quantum hardware), the overhead for quantum error mitigation may be reduced. Furthermore, quantum error correction is only feasible when the quantum device noise is below a threshold value. Furthermore, the utilization of the quantum processor can be improved when the quantum device noise is stable over time thereby requiring less frequent calibration. Attempts have been made to lower and/or stabilize the quantum device noise by calibrating the quantum device based on maximizing the fidelity of each two-qubit gate when performed in isolation. However, such calibrations of the quantum device resulted in drastically different performances under different operating conditions. As a result, there is not currently a means for effectively calibrating the quantum device (quantum hardware) so as to effectively lower the quantum device noise under different operating conditions.

Embodiments of the present disclosure improve such technology by selecting or identifying one or more contextual calibrations to minimize a contextual cost function of a quantum circuit. Examples of such contextual calibrations include, but are not limited to, tuning the amplitude, tuning the frequency duration, tuning the envelopes, recalibrating the error correction for specific qubits, recalibrating the measurement discriminator (identifies the specific quantum state), etc. In one embodiment, the contextual calibration(s) are selected to minimize the contextual cost function of the quantum circuit using a trained machine learning model, where the machine learning model is trained to identify the contextual calibration(s) to be enacted to minimize the contextual cost function of the quantum circuit. Furthermore, in one embodiment, contextual calibrations are selected using reinforcement learning. In one embodiment, an agent learns by reinforcement, where the reward is predicting the correct contextual calibration which lowers the contextual cost function of the quantum circuit. The quantum hardware used to perform an execution of the quantum circuit may then be calibrated using the selected or identified contextual calibration(s). By minimizing the contextual cost function, such as via specific calibrations (e.g., tuning frequency duration, tuning amplitude), the performance of a general quantum device for a particular quantum circuit can be improved. For example, such contextual calibrations, such as at runtime, reduce the quantum device noise under different operating conditions thereby improving device performance. Furthermore, in this manner, there is an improvement in the technical field involving quantum hardware calibrations.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for contextually calibrating quantum hardware, the method comprising:
selecting or identifying one or more contextual calibrations to minimize a contextual cost function of a quantum circuit; and
calibrating said quantum hardware to perform an execution of said quantum circuit using said selected or said identified one or more contextual calibrations.

2. The method as recited in claim 1 further comprising:
determining whether said quantum hardware has been previously contextually calibrated defined by said contextual cost function.

3. The method as recited in claim 2 further comprising:
representing said quantum circuit as a first directed acyclic graph.

4. The method as recited in claim 3 further comprising:
comparing said first directed acyclic graph with a plurality of directed acyclic graphs; and
identifying said one or more contextual calibrations associated with a second directed acyclic graph of said plurality of directed acyclic graphs in response to said first directed acyclic graph matching said second directed acyclic graph.

5. The method as recited in claim 2 further comprising:
determining said one or more contextual calibrations to minimize said contextual cost function of said quantum circuit in response to said quantum hardware not previously been contextually calibrated.

6. The method as recited in claim 5 further comprising:
measuring a fidelity for a layer of quantum gates of said quantum circuit; and
measuring individual quantum gate fidelities for quantum gates located in said layer of quantum gates of said quantum circuit.

7. The method as recited in claim 6 further comprising:
selecting said one or more contextual calibrations to calibrate said layer of quantum gates of said quantum circuit in response to a difference between said measured individual quantum gate fidelities for quantum gates located in said layer of quantum gates of said quantum circuit and said measured fidelity for said layer of quantum gates of said quantum circuit exceeding a threshold value.

8. The method as recited in claim 7, wherein said fidelity for said layer of quantum gates of said quantum circuit is measured by randomly sampling eigenstates of Pauli operators and measuring said sampled eigenstates of Pauli operators, wherein an increase in said fidelity for said layer of quantum gates of said quantum circuit is associated with a decrease in said contextual cost function.

9. The method as recited in claim 1, wherein said selected or said identified one or more contextual calibrations comprise one or more of the following in the group consisting of: tuning amplitude, tuning frequency duration, tuning envelopes, recalibrating error correction for specific qubits, and recalibrating a measurement discriminator.

10. A computer program product for contextually calibrating quantum hardware, the computer program product comprising one or more computer readable storage mediums having program code embodied therewith, the program code comprising programming instructions for:
selecting or identifying one or more contextual calibrations to minimize a contextual cost function of a quantum circuit; and
calibrating said quantum hardware to perform an execution of said quantum circuit using said selected or said identified one or more contextual calibrations.

11. The computer program product as recited in claim 10, wherein the program code further comprises the programming instructions for:
determining whether said quantum hardware has been previously contextually calibrated defined by said contextual cost function.

12. The computer program product as recited in claim 11, wherein the program code further comprises the programming instructions for:
representing said quantum circuit as a first directed acyclic graph.

13. The computer program product as recited in claim 12, wherein the program code further comprises the programming instructions for:
comparing said first directed acyclic graph with a plurality of directed acyclic graphs; and
identifying said one or more contextual calibrations associated with a second directed acyclic graph of said plurality of directed acyclic graphs in response to said first directed acyclic graph matching said second directed acyclic graph.

14. The computer program product as recited in claim 11, wherein the program code further comprises the programming instructions for:
determining said one or more contextual calibrations to minimize said contextual cost function of said quantum circuit in response to said quantum hardware not previously been contextually calibrated.

15. The computer program product as recited in claim 14, wherein the program code further comprises the programming instructions for:
measuring a fidelity for a layer of quantum gates of said quantum circuit; and
measuring individual quantum gate fidelities for quantum gates located in said layer of quantum gates of said quantum circuit.

16. The computer program product as recited in claim 15, wherein the program code further comprises the programming instructions for:
selecting said one or more contextual calibrations to calibrate said layer of quantum gates of said quantum circuit in response to a difference between said measured individual quantum gate fidelities for quantum gates located in said layer of quantum gates of said quantum circuit and said measured fidelity for said layer of quantum gates of said quantum circuit exceeding a threshold value.

17. The computer program product as recited in claim 16, wherein said fidelity for said layer of quantum gates of said quantum circuit is measured by randomly sampling eigenstates of Pauli operators and measuring said sampled eigenstates of Pauli operators, wherein an increase in said fidelity for said layer of quantum gates of said quantum circuit is associated with a decrease in said contextual cost function.

18. A system, comprising:
a memory for storing a computer program for contextually calibrating quantum hardware; and
a processor connected to said memory, wherein said processor is configured to execute program instructions of the computer program comprising:
selecting or identifying one or more contextual calibrations to minimize a contextual cost function of a quantum circuit; and
calibrating said quantum hardware to perform an execution of said quantum circuit using said selected or said identified one or more contextual calibrations.

19. The system as recited in claim 18, wherein the program instructions of the computer program further comprise:
determining whether said quantum hardware has been previously contextually calibrated defined by said contextual cost function.

20. The system as recited in claim 19, wherein the program instructions of the computer program further comprise:
representing said quantum circuit as a first directed acyclic graph.

21. The system as recited in claim 20, wherein the program instructions of the computer program further comprise:
comparing said first directed acyclic graph with a plurality of directed acyclic graphs; and
identifying said one or more contextual calibrations associated with a second directed acyclic graph of said plurality of directed acyclic graphs in response to said first directed acyclic graph matching said second directed acyclic graph.

22. The system as recited in claim 19, wherein the program instructions of the computer program further comprise:
determining said one or more contextual calibrations to minimize said contextual cost function of said quantum circuit in response to said quantum hardware not previously been contextually calibrated.

23. The system as recited in claim 22, wherein the program instructions of the computer program further comprise:
measuring a fidelity for a layer of quantum gates of said quantum circuit; and
measuring individual quantum gate fidelities for quantum gates located in said layer of quantum gates of said quantum circuit.

24. The system as recited in claim 23, wherein the program instructions of the computer program further comprise:
selecting said one or more contextual calibrations to calibrate said layer of quantum gates of said quantum circuit in response to a difference between said measured individual quantum gate fidelities for quantum gates located in said layer of quantum gates of said quantum circuit and said measured fidelity for said layer of quantum gates of said quantum circuit exceeding a threshold value.

25. The system as recited in claim 24, wherein said fidelity for said layer of quantum gates of said quantum circuit is measured by randomly sampling eigenstates of Pauli operators and measuring said sampled eigenstates of Pauli operators, wherein an increase in said fidelity for said layer of quantum gates of said quantum circuit is associated with a decrease in said contextual cost function.
